(19) United States
(12) Patent Application Publication
(10) Pub. No.: US 2026/0113264 A1
(43) Pub. Date: Apr. 23, 2026

(54) METHODS, SYSTEMS, AND COMPUTER READABLE MEDIA FOR TESTING AND VALIDATION OF WIRELESS 802.1Qbv DEVICES USING CUSTOMIZABLE GATE CONTROL LISTS

(71) Applicant: Keysight Technologies, Inc., Santa Rosa, CA (US)

(72) Inventors: Sumalyo Datta, Kolkata (IN); Abhiroop Datta, Kolkata (IN); Ishita Sinha, Bangalore (IN); Mriganka Mouli Ghosh, Hooghly (IN)

(21) Appl. No.: 19/365,744

(22) Filed: Oct. 22, 2025

Related U.S. Application Data
(60) Provisional application No. 63/710,313, filed on Oct. 22, 2024.

(51) Int. Cl. H04L 43/55

(52) U.S. Cl. CPC H04L 43/55

(57) ABSTRACT

A method for testing and validating 802.1Qbv traffic on wireless time sensitive networks includes receiving, via a GCL configuration GUI, user input for defining gate control list parameters and automatically generating, from the user input, a GCL configuration file. The method further includes providing the GCL configuration file to a wireless DUT. The method further includes transmitting, from a test tool, 802.1Qbv test packets to the wireless DUT over a wireless network. The method further includes capturing 802.1Qbv test packets transmitted by the wireless DUT over the wireless network. The method further includes reading timestamps of the captured 802.1Qbv test packets transmitted by the wireless DUT over the wireless network. The method further includes determining whether the timestamps of the captured 802.1Qbv test packets indicate GCL violations by the wireless DUT. The method further includes generating and outputting at least one metric of GCL performance of the wireless DUT.

### PRIORITY CLAIM

This application claims the priority benefit of U.S. Provisional Patent Application Ser. No. 63/710,313, filed Oct. 22, 2024, the disclosure of which is incorporated herein by reference in its entirety.

### TECHNICAL FIELD

The subject matter described herein relates to testing devices that implement time sensitive networking standards. More particularly, the subject matter described herein relates to methods, systems, and computer readable media for testing and validation of 802.1Qbv traffic on a wireless time sensitive network infrastructure using customizable gate control list (GCL) entries.

### BACKGROUND

IEEE 802.1Qbv is an amendment to the IEEE 802.1Q standard. IEEE 802.1Qbv introduces mechanisms to support TSN by providing a way to schedule the transmission of critical data streams. This ensures low-latency and high-reliability delivery. Time sensitive network (TSN) is defined in the IEEE 802.1Q standard to provide deterministic messaging on standard Ethernet. Deterministic communication is important to multiple industries, such as the automotive, manufacturing and transportation industries.

802.1Qbv allows for the definition of a transmission schedule for each port on an 802.1Qbv supported device. The standard introduces a scheduling mechanism that controls the opening and closing of gates based on a repeating schedule. Each gate controls whether a queue is allowed to send frames or not at any given time.

Gates operate based on a time schedule implemented by a gate control list (GCL), opening, and closing at precise intervals to allow or prevent packets from being transmitted from the corresponding queue. The GCL operates on a cyclic basis, meaning the schedule repeats after a defined cycle time. The GCL includes a state (open or closed) for each gate (associated with each queue) for each time interval. By controlling queues with gates, 802.1Qbv provides deterministic transmission behavior, ensuring that critical data streams meet their timing requirements. Devices that implement 802.1Qbv over wireless networks are subject to the same precise timing requirements that implement 802.1Qbv over wired networks.

In light of the precise timing requirements of wireless 802.1Qbv devices, there exists a need for methods systems, and computer readable media for testing the performance of wireless 802.1Qbv devices.

### SUMMARY

A method for testing and validating 802.1Qbv traffic on wireless time sensitive networks using customizable gate control list (GCL) entries includes providing a GCL configuration graphical user interface (GUI) for receiving user input for defining a gate control list including user-customized DUT entries. The method further includes receiving, via the GCL configuration GUI, user input for defining gate control list parameters. The method further includes automatically generating, from the user input, a GCL configuration file. The method further includes providing the GCL configuration file to a wireless device under test (DUT). The method further includes transmitting, from a wireless network interface card of a test tool, 802.1Qbv test packets to the wireless DUT over a wireless network. The method further includes capturing 802.1Qbv test packets transmitted by the wireless DUT over the wireless network. The method further includes reading timestamps of the captured 802.1Qbv test packets transmitted by the wireless DUT over the wireless network. The method further includes determining whether the timestamps of the captured 802.1Qbv test packets indicate GCL violations by the wireless DUT. The method further includes generating and outputting at least one metric of GCL performance of the wireless DUT.

According to another aspect of the subject matter described herein, providing the GCL configuration GUI includes providing a graphical element for enabling a user to configure, for each user-customized DUT entry, an allowed time interval during which a gate is allowed to be open and additional graphical elements for enabling the user to define a cycle time and a base time.

According to another aspect of the subject matter described herein, automatically generating the GCL configuration file includes automatically generating a JavaScript object notation (JSON) file defining a cycle time and allowed intervals for each gate to be controlled by the gate control list.

According to another aspect of the subject matter described herein, the method for validating wireless 802.1Qbv traffic includes transmitting the 802.1Qbv test packets over the wireless network includes transmitting the 802.1Qbv test packets over a Wi-Fi network.

According to another aspect of the subject matter described herein, transmitting the 802.1Qbv test packets to the wireless DUT includes transmitting 802.1Qbv test packets associated with queues corresponding to gates of the wireless DUT.

According to another aspect of the subject matter described herein, determining whether the timestamps of the captured 802.1Qbv packets indicate gate control list violations includes determining whether a timestamp of one of the 802.1Qbv test packets transmitted by the wireless DUT is within an allowed interval of a gate of the wireless DUT for a queue to which the packet is assigned.

According to another aspect of the subject matter described herein, capturing packets transmitted by the wireless DUT includes using a wireless packet capture utility.

According to another aspect of the subject matter described herein, generating and outputting at least one metric of GCL performance of the wireless DUT includes generating and outputting a visualization of packet distributions per gate of the wireless DUT.

According to another aspect of the subject matter described herein, generating and outputting the metric of GCL performance includes generating and outputting a visualization of GCL violations per gate of the wireless DUT.

According to another aspect of the subject matter described herein, a system for testing and validating 802.1Qbv traffic on wireless time sensitive networks using customizable gate control list (GCL) entries is provided. The system includes a test tool including at least one processor and a memory. The system further includes a time sensitive networking (TSN) 802.1Qbv validator implemented by the at least one processor for providing a GCL configuration graphical user interface (GUI) for receiving user input for defining a gate control list including user-customized DUT entries; receiving, via the GCL configuration GUI, user input for defining gate control list parameters; automatically generating, from the user input, a GCL configuration file; providing the GCL configuration file to a wireless device under test (DUT); transmitting, from a wireless network interface card of a test tool, 802.1Qbv test packets to the wireless DUT over a wireless network, wherein the test tool includes a packet capture utility for capturing 802.1Qbv test packets transmitted by the wireless DUT over the wireless network. The wireless 802.1Qbv validator is further configured for reading timestamps of the captured 802.1Qbv test packets transmitted by the wireless DUT over the wireless network; determining whether the timestamps of the captured 802.1Qbv test packets indicate GCL violations by the wireless DUT; and generating and outputting at least one metric of GCL performance of the wireless DUT.

According to another aspect of the subject matter described herein, the GCL configuration GUI includes a graphical element for enabling a user to configure, for each user-customized DUT entry, an allowed time interval during which a gate is allowed to be open and additional graphical elements for enabling the user to define a cycle time and a base time.

According to another aspect of the subject matter described herein, the GCL configuration file comprises a JavaScript object notation (JSON) file defining a cycle time and allowed intervals for each gate to be controlled by the gate control list.

According to another aspect of the subject matter described herein, the test tool incudes a wireless network interface card and the test tool is configured to synchronize timing between the wireless network interface card of the test tool and the wireless DUT.

According to another aspect of the subject matter described herein, the wireless network comprises a Wi-Fi network.

According to another aspect of the subject matter described herein, the 802.1Qbv test packets transmitted wo the wireless DUT are associated with queues corresponding to gates of the wireless DUT.

According to another aspect of the subject matter described herein, the wireless 802.1Qbv validator is configured to determine whether the timestamps of the captured 802.1Qbv packets indicate gate control list violations by determining whether a timestamp of one of the 802.1Qbv test packets transmitted by the wireless DUT is within an allowed interval of a gate of the wireless DUT for a queue to which the packet is assigned.

According to another aspect of the subject matter described herein, the at least one metric of GCL performance of the wireless DUT includes a visualization of packet distributions per gate of the wireless DUT.

According to another aspect of the subject matter described herein, the at least one metric of GCL performance of the wireless DUT includes a visualization of GCL violations per gate of the wireless DUT.

According to another aspect of the subject matter described herein, a non-transitory computer readable medium having stored thereon executable instructions that when executed by a processor of a computer control the computer to perform steps is provided. The steps include providing a gate control list (GCL) configuration graphical user interface (GUI) for receiving user input for defining a gate control list including user-customized DUT entries. The steps further include receiving, via the GCL configuration GUI, user input for defining gate control list parameters. The steps further include automatically generating, from the user input, a GCL configuration file. The steps further include providing the GCL configuration file to a wireless device under test (DUT). The steps further include transmitting, from a wireless network interface card of a test tool, 802.1Qbv test packets to the wireless DUT over a wireless network. The steps further include capturing 802.1Qbv test packets transmitted by the wireless DUT over the wireless network. The steps further include reading timestamps of the captured 802.1Qbv test packets transmitted by the wireless DUT over the wireless network. The steps further include determining whether the timestamps of the captured 802.1Qbv test packets indicate GCL violations by the wireless DUT. The steps further include generating and outputting at least one metric of GCL performance of the wireless DUT.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Exemplary implementations of the subject matter described herein will now be explained with reference to the accompanying drawings, of which:

FIG. 1 is a block diagram illustrating an exemplary architecture for testing a wireless 802.1Qbv device;

FIG. 2 is a diagram illustrating a graphical user interface for defining a customized gate control list for controlling gates of a wireless 802.1Qbv device;

FIG. 3 is a timing diagram illustrating timing of a gate control list for an 802.1Qbv device.

FIG. 4 is a diagram of a portion of a configuration file created from data entered via the graphical user interface of FIG. 2;

FIG. 5 is a flow chart illustrating an exemplary process for testing a wireless 802.1Qbv device;

FIG. 6 is a diagram illustrating a configuration file including a definition of a gate control list;

FIG. 7 is a diagram illustrating an example of an output log generated in response to testing a wireless 802.1Qbv device.

FIG. 8 is a graph illustrating one example of a visualization of performance of a wireless 802.1Qbv device; and

FIG. 9 is a diagram illustrating another example of a visualization of performance of a wireless 802.1Qbv device.

### DETAILED DESCRIPTION

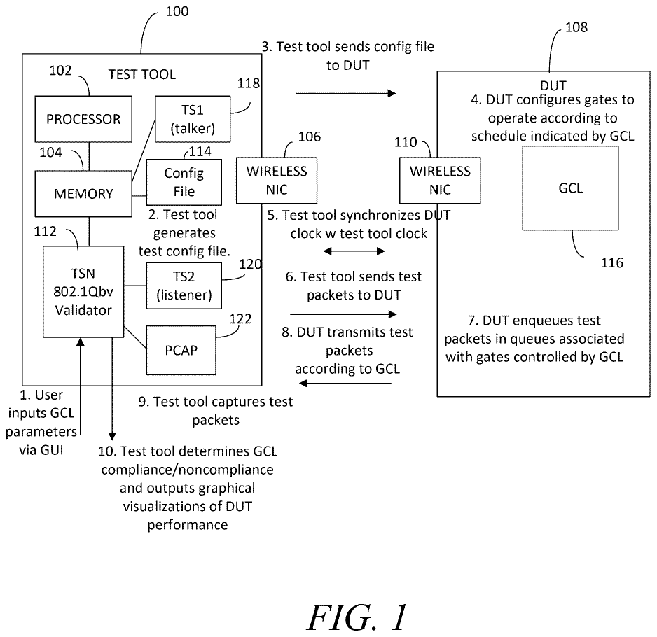

The subject matter described herein includes methods, systems, and computer readable media for testing wireless 802.1Qbv devices using customizable gate control lists. FIG. 1 is a block diagram illustrating an exemplary architecture for testing a wireless 802.1Qbv device. Referring to FIG. 1, a test tool 100 includes at least one processor 102 and memory 104. Test tool 100 also includes a wireless network interface card (NIC) 106. Test tool 100 is configured to test a device under test 108 over a wireless network such as a Wi-Fi (802.11 compliant) network. DUT 108 also includes a wireless NIC 110, which may also be a Wi-Fi NIC.

In the test scenario illustrated in FIG. 1, in step one, a user inputs gate control list parameters for a test via a graphical user interface provided by a wireless TSN 802.1Qbv validator 112. In step 2, test tool 100 automatically generates a test configuration file 114. Test configuration file 114 includes instructions that cause DUT 108 to install a gate control list 116. Gate control list 116 controls the operation of one or more gates of DUT 108 to transmit packets to test tool 100.

In step 3, test tool 100 transmits the configuration file to DUT 108. In step 4, DUT 108 configures its gates to operate according to gate control list 116. In step 5, test tool 100 synchronizes the DUT clock with the test tool clock, which is needed for consistent time stamping. When the user initiates a test, test tool 100, in one example, instantiates test station 1 to be an 802.1Qbv talker 118 and test station 2 to be an 802.1Qbv listener 120. In step 6, test tool 100 sends test packets to DUT 108. In step 7, DUT 108 enqueues the test packets in queues associated with gates controlled by GCL 116. In step 8, DUT 108 transmits the test packets to test tool 100 according to the schedule specified by the gate control list.

In step 9, a packet capture utility 122 associated with test tool 100 captures the test packets transmitted by DUT 108. In step 10, test tool 100 analyzes the received test packets to determine GCL compliance/non-compliance and outputs metrics, such as graphical visualizations, of DUT performance.

One example test suite designed for validation of 802.1Qbv over Wi-Fi TSN works in four phases. First, we configure the GCL that is to be validated during the test (step 1 in FIG. 1), and a config file is generated (step 2 in FIG. 1) with the gate states encoded for the target schedule and store other relevant information, such as packet signature to identify queues and the total cycle time to be validated during the test. This is saved as a JavaScript object notation (JSON)-encoded file and is referred to hereinafter to as the config JSON file. Then, we initiate a timing synchronization process that uses fine time measurement (FTM) to synchronize the DUT with the test tool (step 5 in FIG. 1). FTM is a mechanism similar to generalized precision time protocol (gPTP) that is used to synchronize time between a Wi-Fi access point and a station. In most scenarios used to validate 802.1Qbv functionality, the talker DUT acts as the access point, and the test tool is configured as the station After achieving time synchronization and initiating the test, the test station initiates the capture of 802.1Qbv traffic packets from the DUT (step 9 in FIG. 1) and validates the test packets using scripts. This gives enough flexibility to the user for designing customized test scenarios. Using the GUI, users can load the GCL from a config file and change GCL parameters to create a new scenario and save it to a new configuration file. This import feature can be used also to load GCLs for various test cases (e.g., AVNU Alliance test cases).

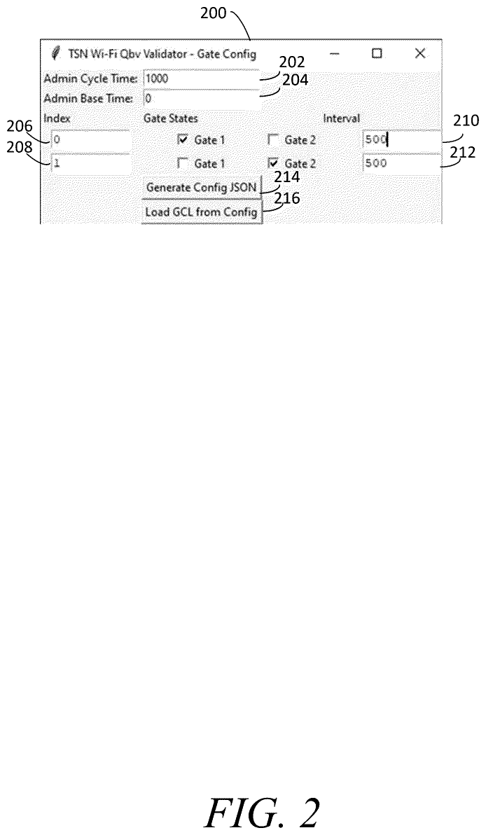

FIG. 2 is a diagram illustrating a graphical user interface for defining a customized gate control list for controlling gates of a wireless 802.1Qbv device. Referring to FIG. 2, a gate control list configuration graphical user interface (GUI) 200 for defining a customized gate control list includes graphical elements 202 and 204 for allowing a user to define a cycle time and a base time, respectively, for the schedule defined by the gate control list. The cycle time is the time for a single iteration of the schedule defined by the gate control list after which the schedule repeats itself. The base time is the start time for the schedule defined by the gate control list. GCL configuration GUI 200 further includes graphical elements 206 and 208, which enable the user to define an index for each gate being configured. The index defines the order in which the gates will be opened during the cycle.

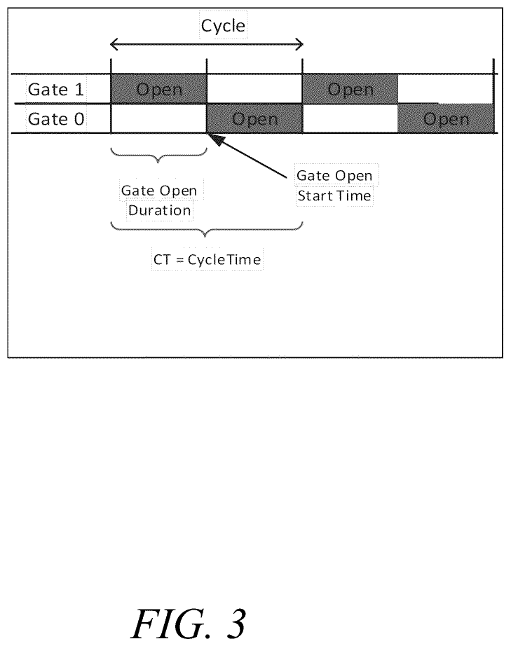

GCL configuration GUI 200 further includes graphical elements 210 and 212, which enable the user to define interval times for each gate. The interval times define the time period during each cycle that the gates remain open. FIG. 3 is a timing diagram illustrating timing of a gate control list for an 802.1Qbv device. In FIG. 3, the timing diagram is for two gates, gate 0 and gate 1, each within an interval time during which the gate is open. The cycle time is also illustrated as the time for all of the gates to open and close, after which the cycle repeats.

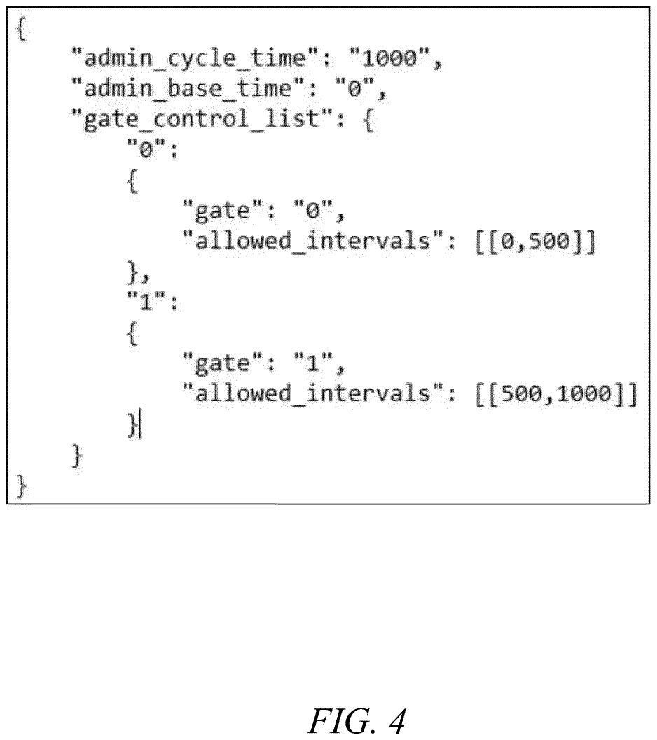

Returning to FIG. 2, graphical user interface 200 further includes graphical element 214, which causes the system to generate the JSON configuration file using the parameters input by the user using GCL configuration GUI 200. FIG. 4 is a diagram of a portion of a configuration file created from data entered via the graphical user interface of FIG. 2. In FIG. 4, the configuration file includes a structure called gate_control_list. The gate_control_list structure includes the allowed interval of zero to 500 milliseconds for gate 0 and 500 to 1000 milliseconds for gate 1. The cycle time is also defined as 1000 milliseconds. GCL configuration GUI 200 further includes a graphical element 216, which enables the user to import a previously created configuration file and edit the configuration file using GCL configuration GUI 200.

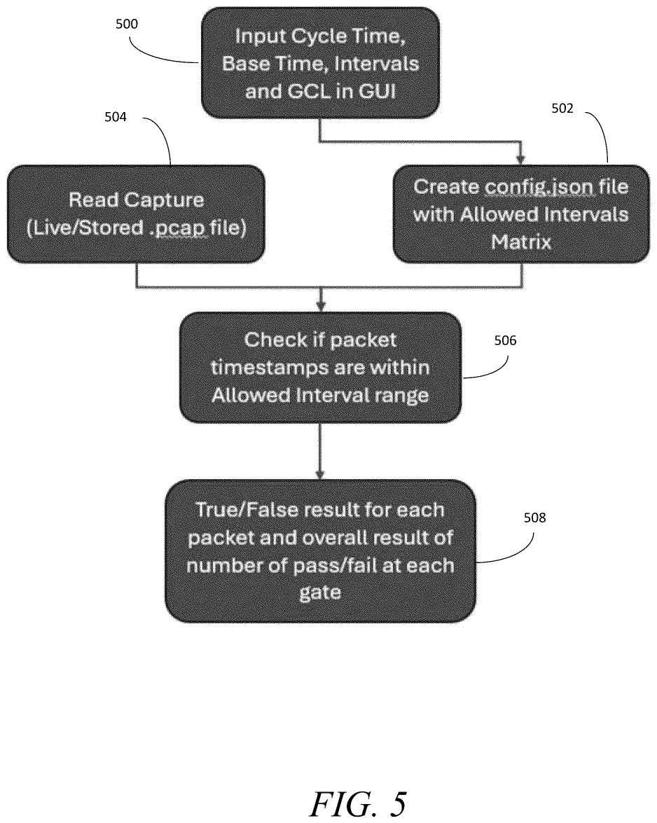

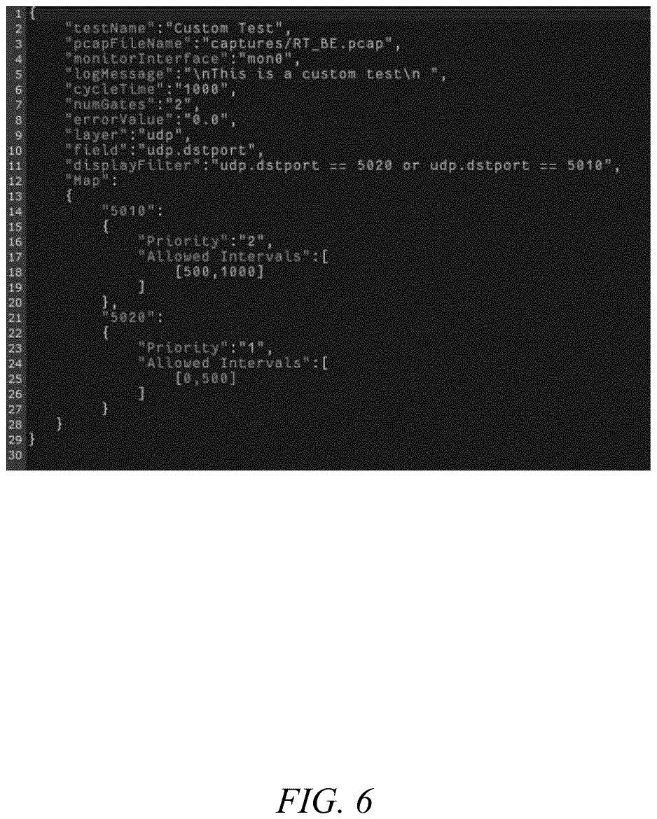

FIG. 5 is a flow chart illustrating an exemplary process for testing a wireless 802.1Qbv device. Referring to FIG. 5, in step 500, the user inputs, via GCL configuration GUI 200 illustrated in FIG. 2, a cycle time, a base time, gate control list indices, and interval times. In step 502, when the user selects graphical element 214 for “generate config. JSON”, TSN 802.1Qbv validator 122 generates the JSON configuration file, an example of which is illustrated in FIG. 6. The gate control list in FIG. 6 includes a schedule for two gates, labeled “5010” and “5020” and defines a cycle time of 1000. The configuration file illustrated in FIG. 6 further includes a packet capture (PCAP) filename indicating the name of the packet capture file used to store 802.1Qbv packets captured during the test. The configuration file further includes a definition of the monitoring interface, a log message, and transport layer parameters. Test tool 100 provides the configuration file to DUT 108, which uses the configuration file to control opening and closing of gates associated with output queues of DUT 108.

After the user starts the test, test tool 100 sends 802.1Qbv packets to DUT 108. DUT 108 enqueues the packets in its output queues and transmits the test packets from its output queues according to the schedule specified by the gate control list. PCAP utility 122 captures the transmitted packets. Returning to FIG. 5, in step 504, wireless TSN 802.1Qbv validator 112 reads the contents of the PCAP file. In step 506, wireless TSN 802.1Qbv validator 112 checks whether packet timestamps are within the allowed ranges of the gate control list. For example, if wireless TSN 802.1Qbv validator 112 detects a packet from the queue associated with gate 5010, and the packet timestamp is 400, then wireless TSN 802.1Qbv validator 112 determines that the packet was transmitted too early and may generate output indicating a gate control list violation. In step 508, wireless TSN 802.1Qbv validator 112 outputs, for each packet, an indication of whether the packet indicates a GCL violation. Wireless TSN 802.1Qbv validator 112 also generates visualizations of GCL pass/fail statistics for each gate.

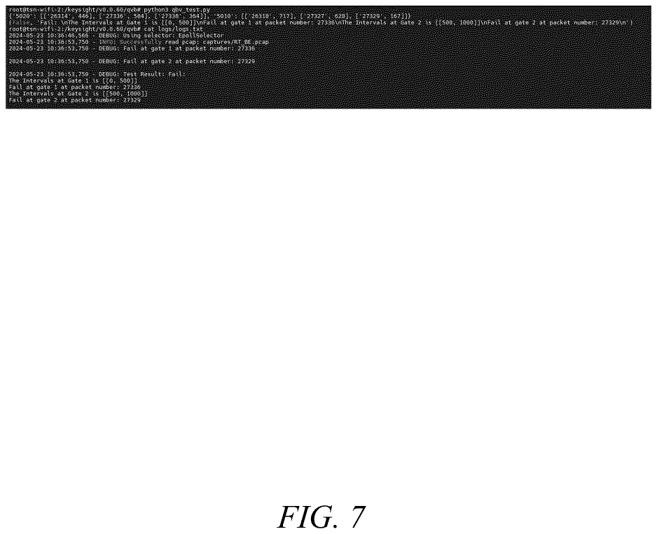

FIG. 7 is a diagram illustrating an example of an output log generated in response to testing a wireless 802.1Qbv device. In FIG. 7, the output log indicates failures at gate #1 and gate #2. For each failure, the log indicates the packet number. The log file also indicates the intervals defined for each gate.

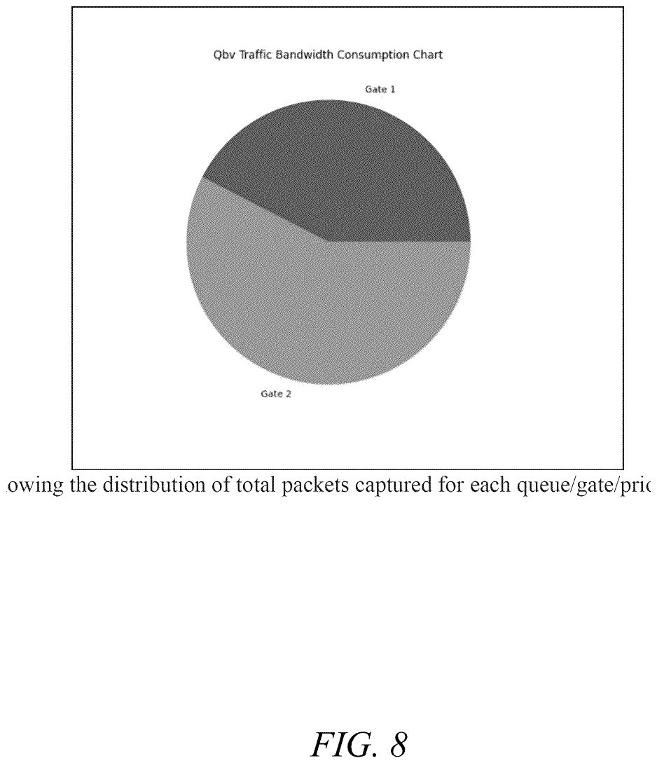

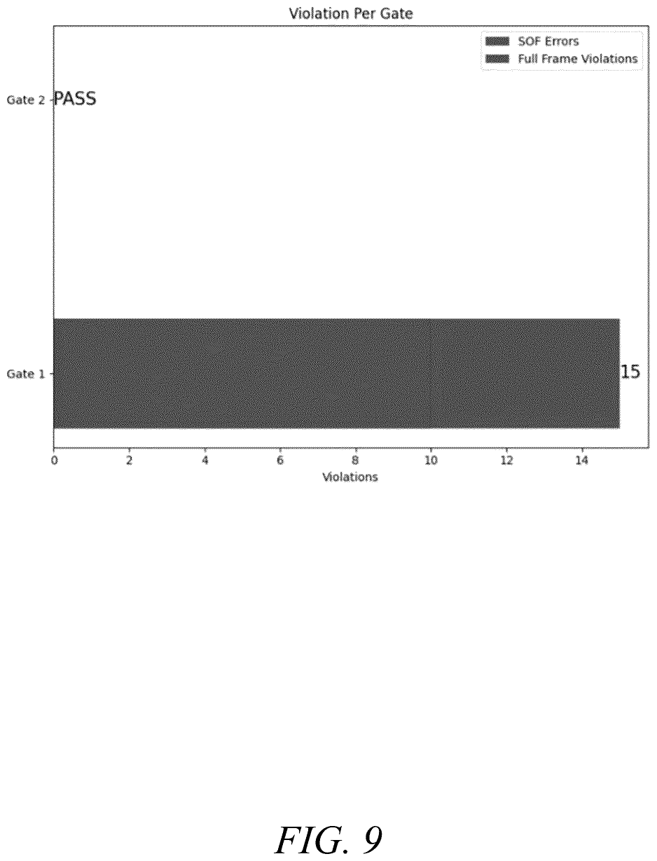

As indicated above, TSN 802.1Qbv validator 112 may generate advanced visualizations of GCL pass/failure statistics at each gate. FIG. 8 is a diagram illustrating one example of a visualization of performance of a wireless 802.1Qbv device. In FIG. 8, the visualization is a pie chart illustrating 802.1Qbv bandwidth consumption per gate. FIG. 9 is a diagram illustrating another example of a visualization of performance of a wireless 802.1Qbv device. In FIG. 9, the visualization is a graph of start of frame (SOF) errors and full frame violations per gate.

Thus, the subject matter described herein includes a test tool for testing 802.1Qbv devices that send traffic over Wi-Fi networks. The methodology described herein validates whether 802.1Qbv devices correctly implement schedules defined by 802.1Qbv gate control lists. The subject matter described herein includes a configuration GCL configuration GUI that enables users to easily create configuration files to be loaded onto devices under test.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for testing and validating 802.1Qbv traffic on wireless time sensitive networks using customizable gate control list (GCL) entries, the method comprising:
providing a GCL configuration graphical user interface (GUI) for receiving user input for defining a gate control list including user-customized DUT entries;
receiving, via the GCL configuration GUI, user input for defining gate control list parameters;
automatically generating, from the user input, a GCL configuration file;
providing the GCL configuration file to a wireless device under test (DUT);
transmitting, from a wireless network interface card of a test tool, 802.1Qbv test packets to the wireless DUT over a wireless network;
capturing 802.1Qbv test packets transmitted by the wireless DUT over the wireless network;
reading timestamps of the captured 802.1Qbv test packets transmitted by the wireless DUT over the wireless network;
determining whether the timestamps of the captured 802.1Qbv test packets indicate GCL violations by the wireless DUT; and
generating and outputting at least one metric of GCL performance of the wireless DUT.

2. The method of claim 1 wherein providing the GCL configuration GUI includes providing a graphical element for enabling a user to configure, for each user-customized DUT entry, an allowed time interval during which a gate is allowed to be open and additional graphical elements for enabling the user to define a cycle time and a base time.

3. The method of claim 1 wherein automatically generating the GCL configuration file includes automatically generating a JavaScript object notation (JSON) file defining a cycle time and allowed intervals for each gate to be controlled by the gate control list.

4. The method of claim 1 comprising synchronizing timing between the wireless network interface card of the test tool and the wireless DUT.

5. The method of claim 1 wherein transmitting the 802.1Qbv test packets over the wireless network includes transmitting the 802.1Qbv test packets over a Wi-Fi network.

6. The method of claim 1 wherein transmitting the 802.1Qbv test packets to the wireless DUT includes transmitting 802.1Qbv test packets associated with queues corresponding to gates of the wireless DUT.

7. The method of claim 6 wherein determining whether the timestamps of the captured 802.1Qbv packets indicate gate control list violations includes determining whether a timestamp of one of the 802.1Qbv test packets transmitted by the wireless DUT is within an allowed interval of a gate of the wireless DUT for a queue to which the packet is assigned.

8. The method of claim 1 wherein capturing packets transmitted by the wireless DUT includes using a wireless packet capture utility.

9. The method of claim 1 wherein generating and outputting at least one metric of GCL performance of the wireless DUT includes generating and outputting a visualization of packet distributions per gate of the wireless DUT.

10. The method of claim 1 wherein generating and outputting the at least one metric of GCL performance includes generating and outputting a visualization of GCL violations per gate of the wireless DUT.

11. A system for testing and validating 802.1Qbv traffic on wireless time sensitive networks using customizable gate control list (GCL) entries, the system comprising:
a test tool including at least one processor and a memory;
a time sensitive networking (TSN) 802.1Qbv validator implemented by the at least one processor for:
providing a GCL configuration graphical user interface (GUI) for receiving user input for defining a gate control list including user-customized DUT entries;
receiving, via the GCL configuration GUI, user input for defining gate control list parameters;
automatically generating, from the user input, a GCL configuration file;
providing the GCL configuration file to a wireless device under test (DUT);
transmitting, from a wireless network interface card of a test tool, 802.1Qbv test packets to the wireless DUT over a wireless network, wherein the test tool includes a packet capture utility for capturing 802.1Qbv test packets transmitted by the wireless DUT over the wireless network and wherein the wireless 802.1Qbv validatory is further configured for reading timestamps of the captured 802.1Qbv test packets transmitted by the wireless DUT over the wireless network;
determining whether the timestamps of the captured 802.1Qbv test packets indicate GCL violations by the wireless DUT; and
generating and outputting at least one metric of GCL performance of the wireless DUT.

12. The system of claim 11 wherein the GCL configuration GUI includes a graphical element for enabling a user to configure, for each user-customized DUT entry, an allowed time interval during which a gate is allowed to be open and additional graphical elements for enabling the user to define a cycle time and a base time.

13. The system of claim 11 wherein the GCL configuration file comprises a JavaScript object notation (JSON) file defining a cycle time and allowed intervals for each gate to be controlled by the gate control list.

14. The system of claim 11 wherein the test tool incudes a wireless network interface card and the test tool is configured to synchronize timing between the wireless network interface card of the test tool and the wireless DUT.

15. The system of claim 11 wherein the wireless network comprises a Wi-Fi network.

16. The system of claim 11 wherein the 802.1Qbv test packets transmitted wo the wireless DUT are associated with queues corresponding to gates of the wireless DUT.

17. The system of claim 16 wherein the wireless 802.1Qbv validator is configured to determine whether the timestamps of the captured 802.1Qbv packets indicate gate control list violations by determining whether a timestamp of one of the 802.1Qbv test packets transmitted by the wireless DUT is within an allowed interval of a gate of the wireless DUT for a queue to which the packet is assigned.

18. The system of claim 11 wherein the at least one metric of GCL performance of the wireless DUT includes a visualization of packet distributions per gate of the wireless DUT.

19. The system of claim 11 wherein the at least one metric of GCL performance of the wireless DUT includes a visualization of GCL violations per gate of the wireless DUT.

20. A non-transitory computer readable medium having stored thereon executable instructions that when executed by a processor of a computer control the computer to perform steps comprising:
providing a gate control list (GCL) configuration graphical user interface (GUI) for receiving user input for defining a gate control list including user-customized DUT entries;
receiving, via the GCL configuration GUI, user input for defining gate control list parameters;
automatically generating, from the user input, a GCL configuration file;
providing the GCL configuration file to a wireless device under test (DUT);
transmitting, from a wireless network interface card of a test tool, 802.1Qbv test packets to the wireless DUT over a wireless network;
capturing 802.1Qbv test packets transmitted by the wireless DUT over the wireless network;
reading timestamps of the captured 802.1Qbv test packets transmitted by the wireless DUT over the wireless network;
determining whether the timestamps of the captured 802.1Qbv test packets indicate GCL violations by the wireless DUT; and
generating and outputting at least one metric of GCL performance of the wireless DUT.
